(19) United States
(12) Patent Application Publication
(10) Pub. No.: US 2011/0077114 A1
(43) Pub. Date: Mar. 31, 2011

(54) ANCHORED MECHANICAL STRAP TENSIONER FOR MULTI-STRAND TENSIONING

(75) Inventor: George L. Markley, Montour Falls, NY (US)

(73) Assignee: BorgWarner Inc., Auburn Hills, MI (US)

(21) Appl. No.: 12/994,210

(22) PCT Filed: Jun. 4, 2008
(86) PCT No.: PCT/US08/65701

§ 371 Date: Nov. 23, 2010

(51) Int. Cl. F16H 7/08; F02B 67/06

(52) U.S. Cl. 474/111

(57) ABSTRACT

A tensioner for a closed loop power transmission system for an internal combustion engine having a drive shaft terminating in a sprocket and at least one camshaft, each terminating in a sprocket, with a single continuous chain wrapping around all of the sprockets. The tensioner contains a pair of elongated tensioning arms, each one in slidable contact with one of the two strands of chain that traverses between the driving sprocket and the driven sprocket(s). Each tensioning arm contains a wear face that remains in constant slidable contact with the strand of chain to which it is adjacent. An adjusting arm connects one of the ends of the tensioning arms. The adjusting arm has a ratchet means that adjusts for the backlash in the system and takes up any slack in the chain.

### BACKGROUND OF THE INVENTION

1. Field of the Invention

The invention pertains to the field of chain tensioners. More particularly, the invention pertains to a tensioner for two strands of chain that contains a ratcheting device.

2. Description of Related Art

A tensioning device, such as a hydraulic tensioner, is used as a control device for a power transmission chain, or similar power transmission device, as the chain travels between a plurality of sprockets that are connected to the operating shafts of an internal combustion engine. In this system, the chain transmits power from a driving shaft to a driven shaft, so that part of the chain is slack and part of the chain is tight. Generally, it is important to impart and maintain a certain degree of tension on the chain to prevent noise, slippage, or the unmeshing of teeth as in the case of a toothed chain. Prevention of such slippage is particularly important in the case of a chain driven camshaft in an internal combustion engine because the jumping of teeth will throw off the camshaft timing, possibly causing damage to the engine or rendering it inoperative.

However, in the harsh environment of the internal combustion engine, numerous factors cause fluctuations in the tension of any given portion of the chain. For instance, extreme temperature fluctuations and differences in the relative rates of thermal expansion coefficients among the various parts of the engine can cause the chain tension to vary between excessively high or very low levels. During prolonged use, wear to the components of the power transmission system can cause a steady decrease in chain tension. In addition, camshaft and crankshaft induced torsional vibrations cause considerable variations in chain tensions. For example, the reverse rotation of an engine, occurring during stopping of the engine or in failed attempts at starting the engine, can also cause significant fluctuations in chain tension. For these reasons, a mechanism is desired to remove excessive tensioning forces on the tight side of the chain while, at the same time, ensuring that adequate tension is applied to the slack side of the chain.

Hydraulic tensioners are a common method of maintaining proper chain tension. In general, these mechanisms employ a lever arm that pushes against the chain on the slack side of the power transmission system. The lever arm pushes toward the chain, tightening the chain when the chain is slack, and it must remain relatively immoveable when the chain tightens.

To achieve this, a hydraulic tensioner 1, as shown in prior art FIG. 1, typically contains a rod or cylinder as a piston 2, which is biased in the direction of the chain by a tensioner spring 3. The piston 2 is housed within a cylindrical housing 5, having an interior space which is open at the end facing the chain and closed at the other end. The interior space of the housing contains a pressure chamber 4 which is connected to a reservoir or exterior source of hydraulic fluid pressure via channels or ducts. The pressure chamber 4 is typically formed between the housing 5 and the piston 2, and it expands or contracts when the piston 2 moves within the housing 5.

Typically, valves are employed to regulate the flow of fluid into and out of the pressure chamber. For instance, an inlet check valve such as a ball-check valve opens to permit fluid to flow into the pressure chamber 4 when the pressure inside the chamber has decreased as a result of the outward movement of the piston 2. When the pressure in the pressure chamber is high, the inlet check valve closes, preventing fluid from exiting the pressure chamber. Closing the inlet check valve prevents the piston chamber from contracting, which in turn prevents the piston from retracting, thereby achieving a so-called “no-return” function.

Many tensioners also employ a pressure relief mechanism that allows fluid to exit the pressure chamber when the pressure in the chamber is high, thus allowing the piston to retract in a regulated manner in response to rapid increases in chain tension. In some tensioners, the pressure relief mechanism is a spring biased check valve. The check valve opens when the pressure exceeds a certain pressure point. Some tensioners may employ a valve which performs both the inlet check function as well as the pressure relief function.

Other mechanisms employ a restricted path through which fluid may exit the fluid chamber, such that the volume of flow exiting the fluid chamber is minimal unless the pressure in the fluid chamber is great. For instance, a restricted path may be provided through the clearance between the piston and bore, through a vent tube in the protruding end of the piston, or through a vent member between the fluid chamber and the fluid reservoir.

A hydraulic tensioner used with a tensioner arm or shoe is shown in Simpson et al., U.S. Pat. No. 5,967,921, incorporated herein by reference. Hydraulic chain tensioners typically have a plunger slidably fitted into a chamber and biased by a spring to provide tension to a specific strand of chain. A lever, arm or shoe is often used at the end of the plunger to assist in the tensioning of the chain. The hydraulic pressure from an external source, such as an oil pump or the like, flows into the chamber through passages formed in the housing. The plunger is urged outward against the arm by the combined forces of the hydraulic pressure and the spring tension.

When a force is applied to move the plunger in a reverse direction (retracting into the housing) away from the chain, typically a check valve will restrict the flow of fluid out of the chamber. In this way, the tensioner achieves the no-return function, i.e., movements of the plunger are easy in one direction (outward and away from the housing) but difficult in the reverse direction.

Blade tensioners are commonly used to control a chain or belt where load fluctuations are not so severe as to overly stress the spring or springs. A ratchet with a backlash mechanism may be added to tensioners to limit the effective backward or untensioned travel of the tensioning device.

Prior art FIG. 2 shows a conventional blade tensioner. The blade tensioner 10 includes a blade shoe 11 having a curved chain sliding face and numerous blade springs 21, preferably made of a seasoned metallic material to impart spring-like tension to the blade springs 21. The blade springs 21 are arranged in layers on the opposite side of the blade shoe 11 from the chain sliding face, and exert a biasing force on the blade shoe 11. The ends of each spring-shaped blade spring 21 are inserted in the indented portions 14 and 15, which are formed in the distal portion 12 and proximal portion 13 of the blade shoe 11, respectively.

A bracket 17 is provided for mounting the blade tensioner 10 in an engine. Holes 18 and 19 are formed in the bracket 17. Bolts or other secure mounting means are inserted into holes 18 and 19 for securing bracket 17 to the engine. A sliding face 16 is formed on the distal portion of the bracket 17 and slidably contacts the distal portion of the blade shoe 11. A pin 20 secured on the bracket 17 supports the proximal portion 13 of the blade shoe 11 so that it may pivot with the changes in the position of the chain.

FIG. 3 shows a chain tensioning device that has a pair of arms 202, 203 which are joined by a pivot 204. The arms 202, 203 are urged apart so that arm 203 applies tensioning force to a chain (not shown) by means of a spring 206 loaded cam block 205. To prevent collapse of arm 203 during load reversals of the chain, a catch disc 209 and rod 208 are arranged to prevent return movement of the spring loaded cam block 205.

FIG. 4 shows a tensioner that uses a ratchet device in a chain drive power transmission system. The power transmission system includes a drive shaft 302 having a sprocket 303 that uses a continuous loop chain 306 to drive the sprocket 305 of a driven shaft, such as a camshaft, 304. The ratchet tensioner 301 contains a tensioner housing 307 having a hole 312 for receiving a plunger 308 and a ratchet pawl 317 pivotally mounted about shaft 316 to the tensioner housing 307 and biased by a ratchet spring 318. The plunger 308 has teeth on one side of its outer perimeter to engage the ratchet pawl 317. The plunger 308 is biased outward from the hole 312 toward contact with tension lever 310 by the introduction of pressurized fluid into the hollow section 313 and by the force of the plunger spring 314. The tensioner lever 310 pivots on support shaft 309 and has a sliding face 311 that contacts and applies tension to the slack side of the timing chain 306. The rearward movement of the plunger 308 back into the hole 312 is limited by the one way engagement of the ratchet pawl 317 with the teeth on the plunger.

Prior art FIGS. 5a, 5b, and 5c show a tensioner 110 for a closed loop power transmission system of an internal combustion engine. The power transmission system includes a drive shaft terminating in a sprocket 102 and at least one camshaft, each in turn terminating in a sprocket 104, 104′, with a single continuous chain 100 wrapping around the sprockets. The tensioner 110 contains a pair of elongated tensioning arms 112, 112′, each one in slidable contact with one of the two strands of chain 100 that traverses between the driving sprocket 102 and the driven sprocket(s) 104, 104′. Each tensioning arm 112. 112′ has a first end 107, 107′, a second end 109, 109′ and a mid point and may be pivotally mounted 106, 106′, 106a, 106a′ to the engine housing at either the first end 107, 107′, the mid point or at some location therebetween. Each tensioning arm 112, 112′ contains a wear face 105, 105′ to maintain slidable contact with the strand of chain with which it is operably engaged.

The second end 109, 109′ of each tensioning arm 112, 112′ is pivotally connected to the other tensioning arm by an adjusting arm 130. The adjusting arm 130 includes two pairs of rigid elongated straps 134, 134′, 136, 136′ that adjustably overlap with each other substantially in the middle of the length of the adjusting arm 130. The overlapping ends 142, 142′ of the first pair of elongated straps 134, 134′ terminate in hook shapes to provide a seat for a first end of a lengthening coil spring 160. The overlapping ends 150, 150′ of the second pair of elongated straps 136, 136′ also terminate in hook shapes that insert through slots 146, 146′ formed in each of the first pair of elongated straps 134, 134′. The hook shaped ends 150, 150′ of the second pair of straps 136, 136′ provide a seat for a second end of the lengthening coil spring 160. Each strap of the first pair of elongated straps 134, 134′ contains a rack of teeth 172′ that operatively meshes with a rack of teeth 170 on each strap of the second pair of elongated straps 136, 136′. The lengthening coil spring 160 urges the overlap of both pair of elongated straps 134, 134′, 136, 136′ so that the adjusting arm 130 continues to shorten in response to increasing slack or wear conditions experienced by the chain 100. The meshing teeth provide a “no-return” feature by engaging the teeth in only one direction.

### SUMMARY OF THE INVENTION

The present invention is a tensioner for a closed loop power transmission system of an internal combustion engine. The power transmission system includes a drive shaft terminating in a sprocket and at least one camshaft, each in turn terminating in a sprocket, with a single continuous chain wrapping around the sprockets. The tensioner contains a pair of elongated tensioning arms, each one in slidable contact with one of the two strands of chain that traverses between the driving sprocket and the driven sprocket(s). Each tensioning arm has a first end and a second end and the first end of the tensioning arms are pivotally attached to the engine. Each tensioning arm contains a wear face to maintain slidable contact with the strand of chain with which it is operably engaged.

The second end of each tensioning arm is pivotally connected to the other tensioning arm by an adjusting arm. The adjusting arm includes two pairs of rigid elongated straps that adjustably overlap with each other substantially in the middle of the length of the adjusting arm. An anchoring base is present between the two rigid elongated straps. The overlapping ends of the first pair of elongated straps terminate in hook shapes and together with the anchoring base provide a seat for a first coil spring. The overlapping ends of the second pair of elongated straps also terminate in hook shapes that insert through slots formed in each of the first pair of elongated straps. The hook shaped ends of the second pair of straps together with the anchoring base provide a seat for a second coil spring. Each strap of the first pair of elongated straps contains a rack of teeth that operatively meshes with a rack of teeth on each strap of the second pair of elongated straps. The first and second coil spring urge the overlap of both pair of elongated straps so that the adjusting arm continues to shorten in response to increasing slack or wear conditions experienced by the chain. The meshing teeth provide a “no-return” feature by engaging the teeth in only one direction

### BRIEF DESCRIPTION OF THE DRAWING

FIG. 1 shows a prior art hydraulic tensioner.

FIG. 2 shows a prior art blade type tensioner.

FIG. 3 shows an alternate prior art tensioner.

FIG. 4 shows a prior art ratcheting tensioner.

FIG. 5a shows a front elevational view of a prior art tensioner. FIG. 5b shows an isometric view of the ratcheting device in the adjustment arm of the prior art tensioner of FIG. 5a. FIG. 5c shows two straps segments of the prior art adjustment arm of the prior art tensioner of FIG. 5a.

FIG. 6 shows an isometric view of the ratcheting tensioner of the present invention.

FIG. 7 shows an isometric view of the ratcheting tensioner of the present invention without sprockets.

FIG. 8 shows a top view of the ratcheting tensioner of the present invention.

FIG. 9 shows a front view of the ratcheting tensioner of the present invention.

FIG. 10 shows two straps having opposing ratchet teeth.

FIG. 11 shows an exploded view of overlapping straps separated to show the ratchet teeth.

FIG. 12 shows an isometric view of the two pairs of strap.

FIG. 13 shows a top view of two pairs of straps.

FIG. 14 shows an isometric view including springs.

FIG. 15 shows a top view including springs.

FIG. 16 shows an isometric view including the anchoring base, pins, snap rings, and back straps.

FIG. 17 shows an isometric view including front straps.

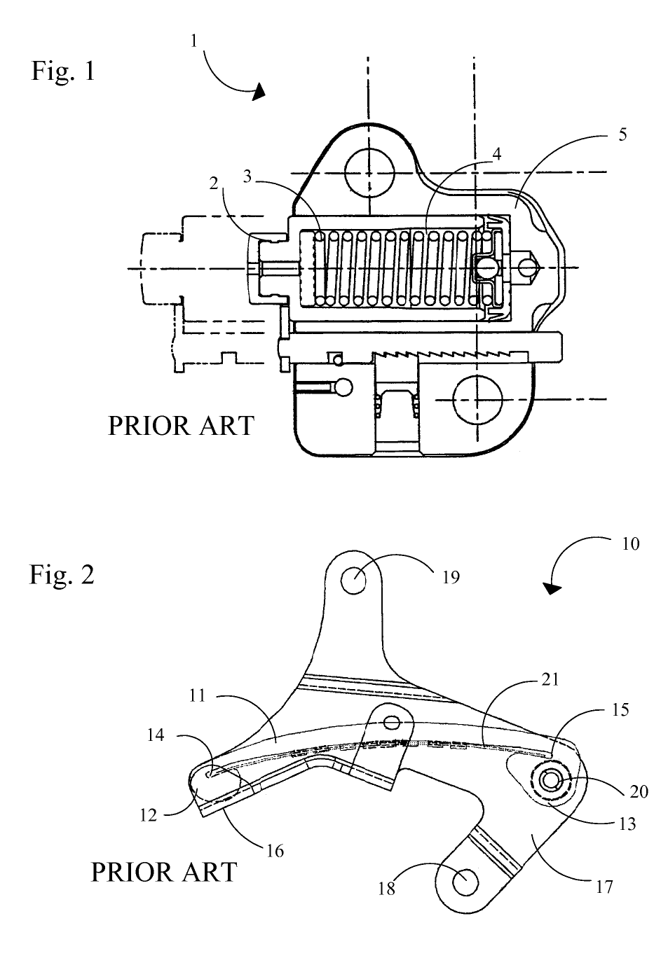

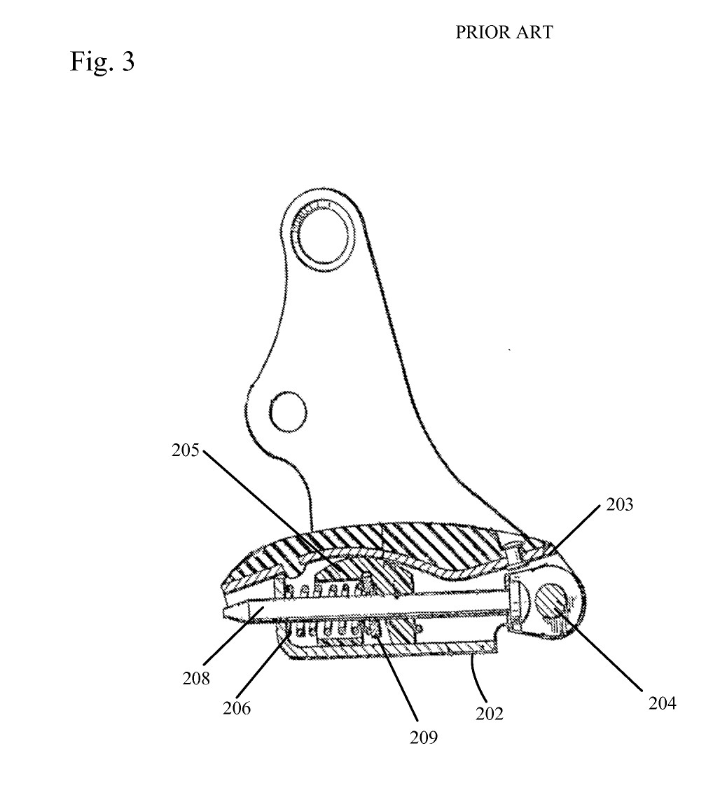

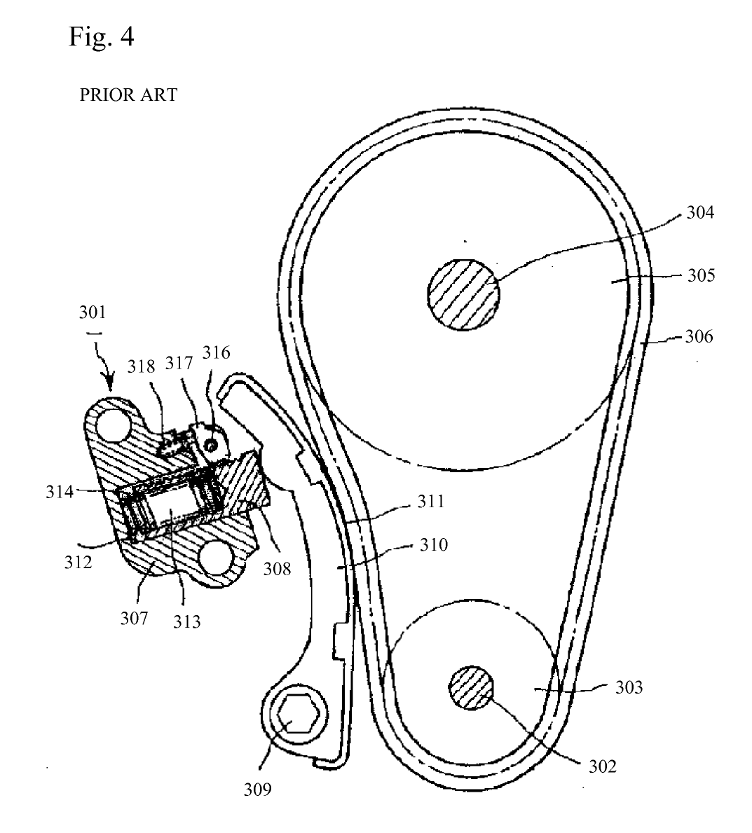

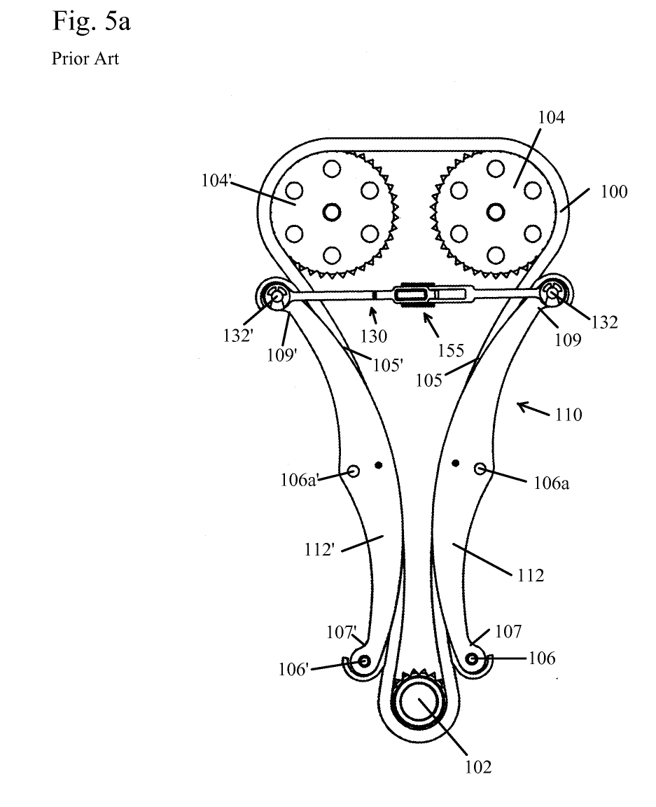

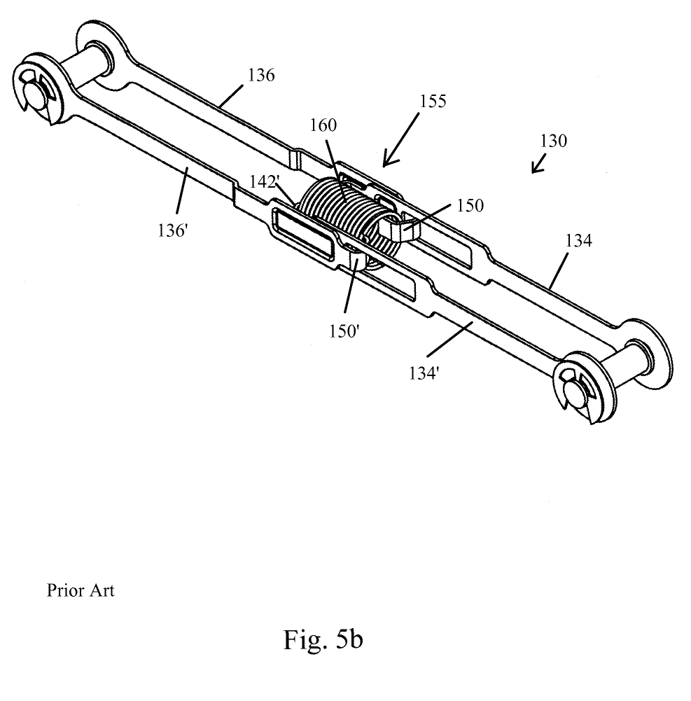

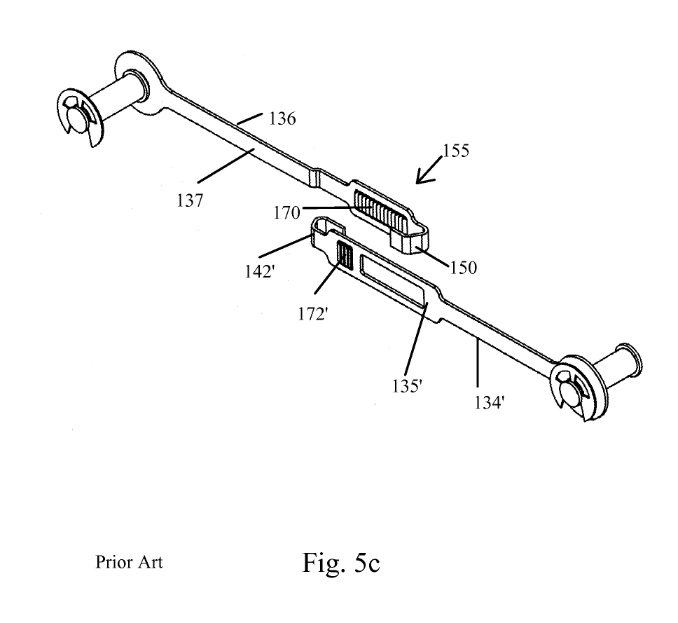

### DETAILED DESCRIPTION OF THE INVENTION

The tensioner 510 of the present invention is operatively engaged with a closed loop power transmission system of an internal combustion engine. The power transmission system contains a driving sprocket 102 and at least one driven sprocket 104, 104′. Power from the engine's drive shaft is transmitted from the driving sprocket 102 to the driven sprockets by means of a chain 100 or drive belt. Most commonly used with internal combustion engines are chain drives. Proper tension must be applied to the chain 100 at all times in order to prevent the jumping of the sprocket teeth by the chain during slackening of any portion of the chain during operation or as a result of increasing wear of the components over time.

The tensioner 510 includes a tensioning arm 512 that is operatively engaged with the outer surface of one of the strands of chain between the driving sprocket 102 and one of the driven sprockets 104. The second tensioning arm 512′ of tensioner 510 is operatively engaged with the outer surface of the other strand of chain between the driving sprocket 102 and a second driven sprocket 104′. It should be understood that the tensioner 510 of the present invention is also capable of being used in a closed loop power transmission system that has only one driving and one driven sprocket.

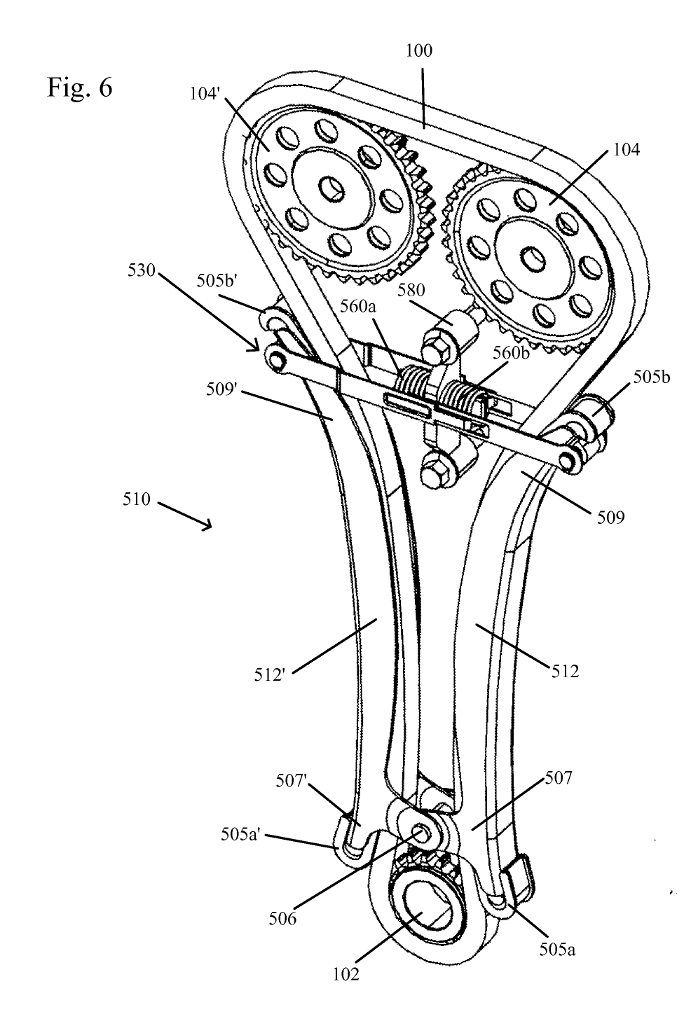

Each tensioning arm 512, 512′, may be pivotally secured to the face of the engine housing (not shown) by pivot mounting means 506 at respective first ends 507 and 507′ of each tensioning arm 512 and 512′, as shown in FIGS. 6, 7, and 9. The pivot mounting means 506 is present between the chain strands allows the tensioning arms 512 and 512′ to pivot in response to changes in the tension of the chain 100. Alternative pivot mounting points may also be used. While both tensioner arms 512, 512′ are shown as being mounted to the same pivot point, multiple pivot points may be present and each arm may be mounted to different pivot points.

Each tensioning arm 512 and 512′ contains an elongated rectangular shaped chain wear face 505 and 505′, respectively, that is semi-rigidly mounted along the length of each tensioning arm facing the strand of chain 100 with which it is operatively engaged. Each chain wear face 505 and 505′ terminates in hooked ends that wrap around the ends of the tensioning arm on which it is installed. Each chain wear face 505 or 505′ is the contact surface with the strand of chain with which its corresponding tensioning arm is engaged.

Each chain wear face 505 and 505′ has a first end 505a and 505a′, respectively, and a second end 505b and 505b′, respectively. Each first end 505a and 505a′ is joined to its corresponding second end 505b and 505b′ by a middle portion that acts as the chain sliding face 505c and 505c′. This is best shown in FIG. 7. Each chain sliding face 505c and 505c′ is in sliding contact with a different strand of chain 100. Each first end 505a and 505a′ and each second end 505b and 505b′ of its respective chain wear face 505 and 505′ are curved underneath and around towards the center of the corresponding wear face. Each chain wear face 505 and 505′ is longer than its corresponding tensioning arm 512 and 512′ such that each curved first end 505a and 505a′ receives the respective first end 507 and 507′ of the corresponding tensioning arm 512 and 512′ and each curved second end 505b and 505b′ receives the respective second end 509 and 509′ of the corresponding tensioning arm 512 and 512′, thereby loosely securing each chain wear face 505 and 505′ to its corresponding tensioning arm 512 and 512′. The chain wear faces 505 and 505′ are preferably made of a material that is semi-flexible at engine operating temperatures, in order to allow them to bow out to conform to the changing tension conditions of the chain 100. Optionally, additional biasing means may be provided by one or more blade springs located between the tensioning arm 512, 512′ and the rear surface of each of the chain wear faces 505 and 505′. A gap clearance exists between each of the first ends 505a and 505a′ of the chain wears faces 505 and 505′ and the first ends 507 and 507′ of tensioning arms 512 and 512′. As well, a gap clearance exists between the second ends 505b and 505b′ of the chain wear faces 505 and 505′ and the second ends 509 and 509′ of tensioning arms 512 and 512′.

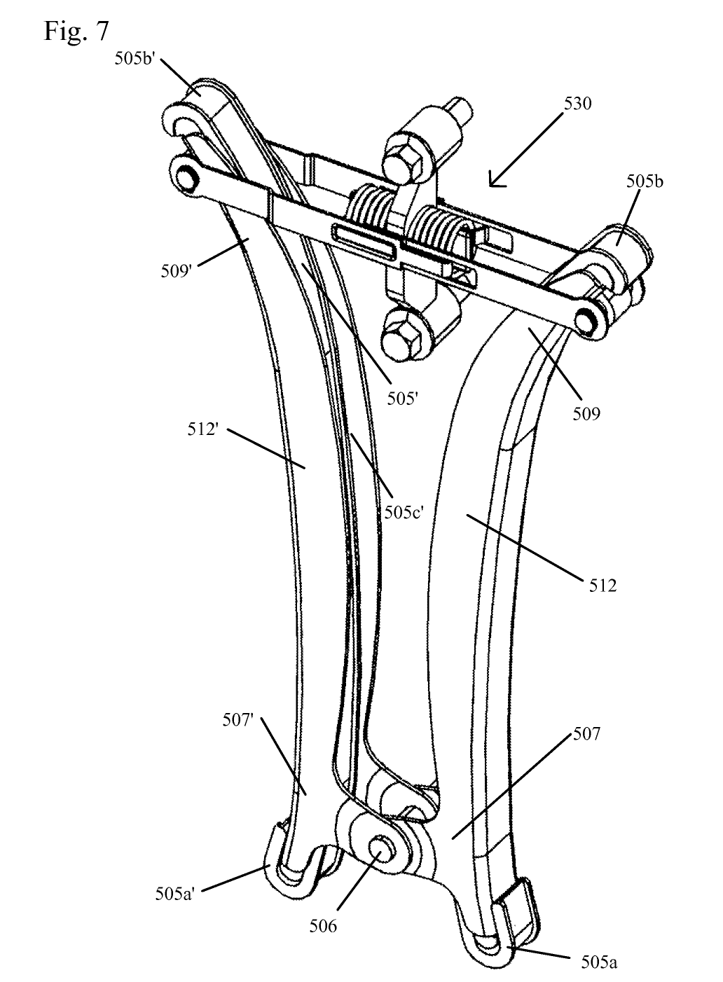

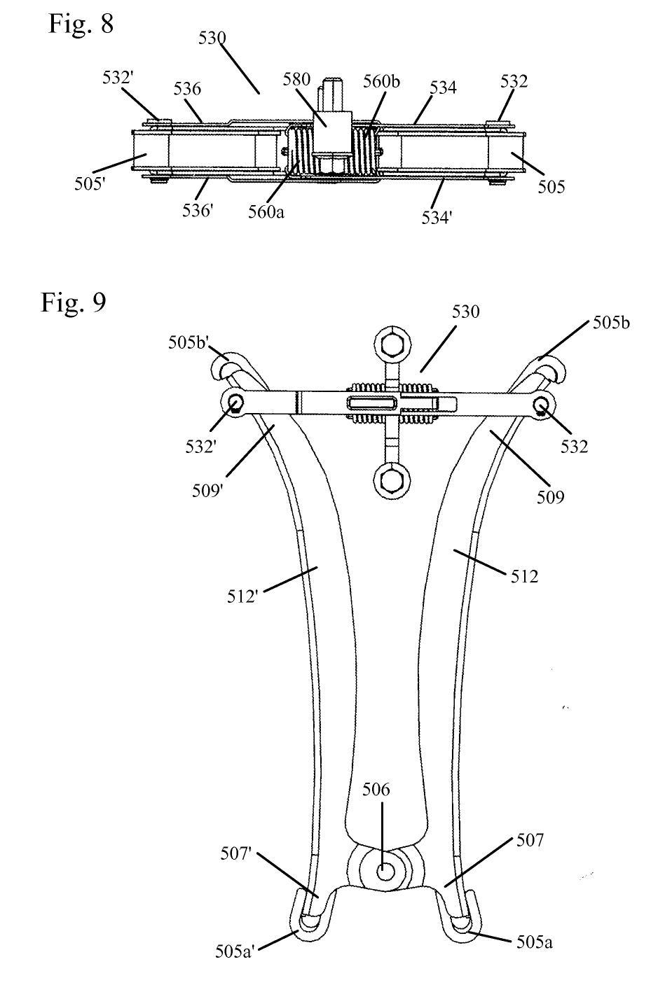

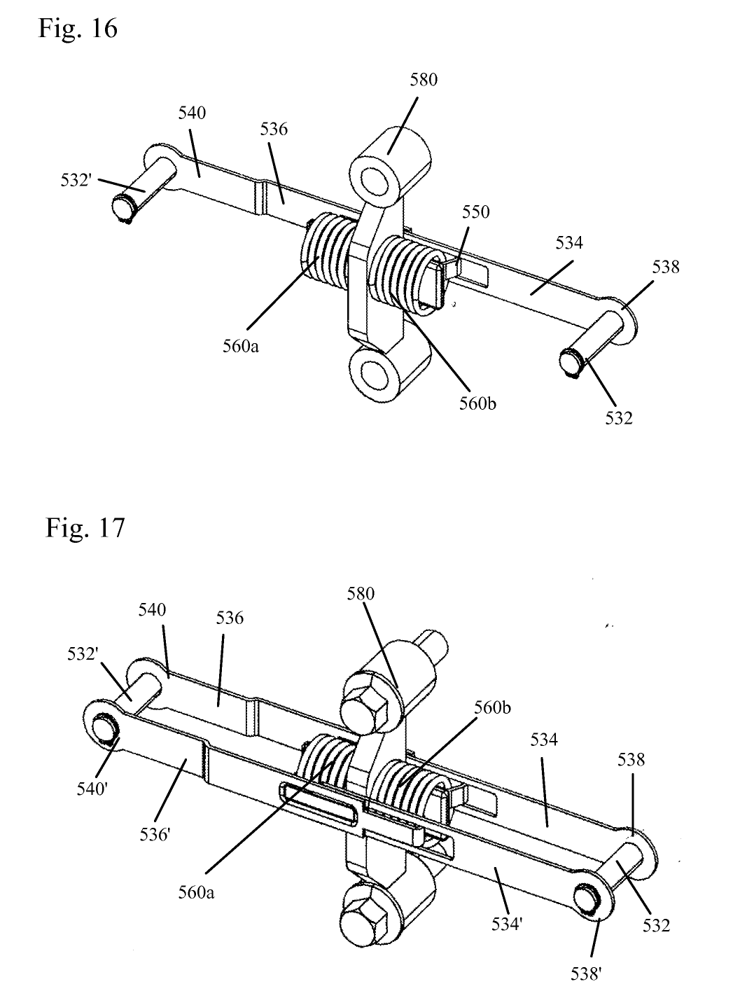

The second ends 509 and 509′ of each of the respective tensioning arms 512 and 512′, are connected to an adjusting arm 530 as shown in FIGS. 8 and 9. Referring to FIGS. 16 and 17, the second end 509 of the tensioning arm 512 is secured to first ends 538 and 538′, respectively of a first pair of elongated straps 534 and 534′ by a pin 532. The second end 509′ of tensioning arm 512′ is secured to first ends 540 and 540′, respectively, of a second pair of elongated straps 536, 536′, by pin 532′. Elongated straps 534, 534′, 536 and 536′ may be made of any rigid material, such as, for example, steel, aluminum, alloys thereof, or non-deformable synthetic resinous composite materials.

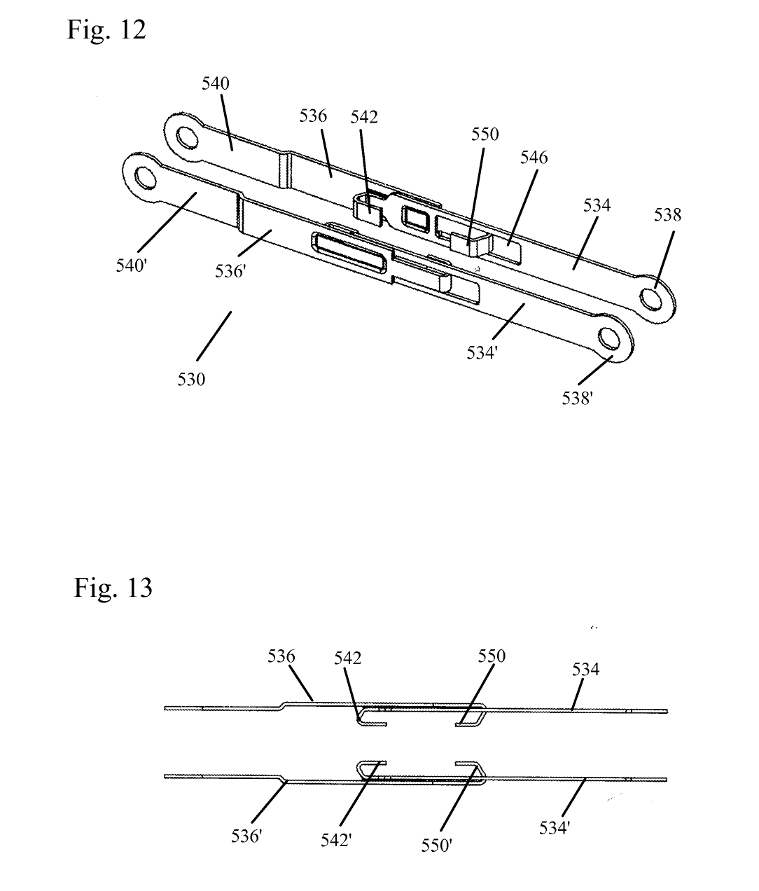

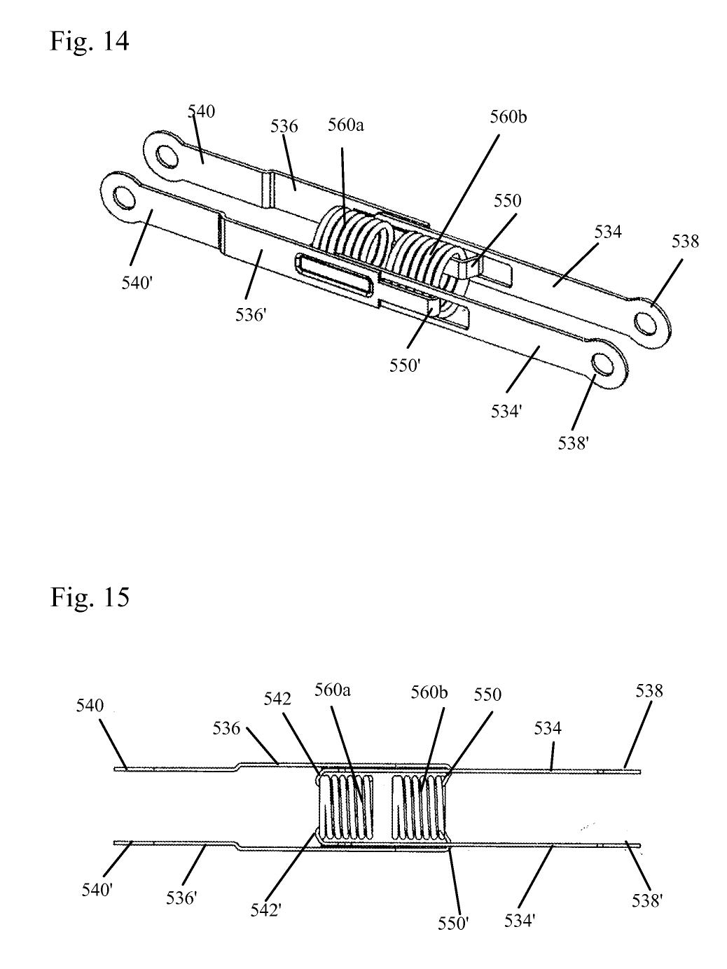

Referring to FIGS. 12 and 13, the second ends 542 and 542′, of their respective first pair of elongated straps 534 and 534′ each terminate into a substantially 180° hook shape. The second ends 550 and 550′ of their respective second pair of elongated straps 536 and 536′ also each terminate into a substantially 180° hook shape. Second end 550 is slidably engaged through a longitudinal slot 546 in elongated strap 534 and second end 550′ is slidably engaged through a longitudinal slot 146′ in elongated strap 534′.

Second ends 542 and 542′ and an anchoring base 580 securely mounted to the engine housing, present between the pairs of straps 534, 534′, 536, 536′ creates a seat to secure a first coil spring 560a. The first end of the first coil spring 560a is secured to the second ends 542 and 542′ and the second end of the first coil spring is mounted to the anchoring base 580. Second ends 550 and 550′ and anchoring base 580 securely mounted to the engine housing creates a seat to secure the second coil spring 560b. The first end of the second coil spring 560b is secured to the second ends 550 and 550′. The second end of the second coil spring 560b is mounted to anchoring base 580.

The resting state of each of the coil springs 560a, 560b is longer than its length when installed in the adjusting arm 130 in order to provide a force to bias the respective second ends 542 and 542′ away from second ends 550 and 550′ and the anchoring base 580. The elongating force of coil springs 560a and 560b urges the first pair of elongated straps 534 and 534′ to overlap with the second pair of elongated straps 536 and 536′, when required, in response to increasing slack or wear conditions exhibited by the chain 100.

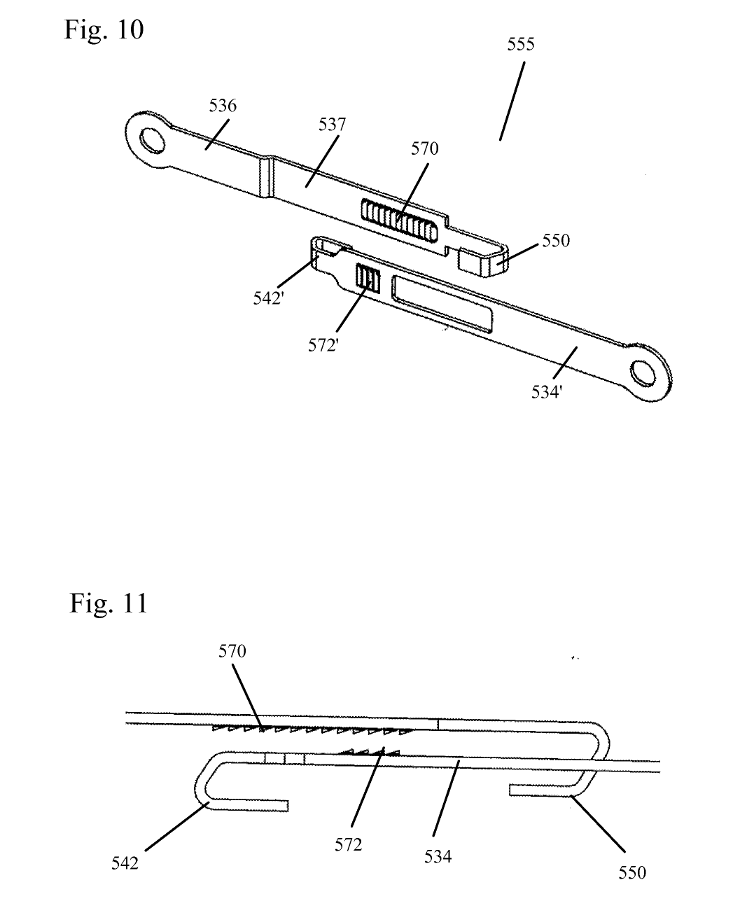

Referring to FIGS. 10 and 11, various elements of the adjusting arm 530 are removed to better show certain features of ratcheting means 555. Located on the inner surface 537 and in proximity to the second end 550 of elongated strap 536 is an inner rack of teeth 570. Located on the outer surface 535′ (not shown) and in proximity to the second end 542′ of elongated strap 534′ is an outer rack of teeth 572′. Although not shown in these figures, the mirror image elongated strap 536′ also contains the same elements as does elongated strap 536. Specifically, on the inner surface 537′ and in proximity to the second end 550′ of elongated strap 536′ is a rack of teeth 570′. The mirror image elongated strap 534 contains similar elements as are present on elongated strap 534′, that is, on the outer surface 535 (not shown) and in proximity to the second end 542 of elongated strap 534 is an outer rack of teeth 572. When the adjusting arm 530 is fully assembled, the inner rack of teeth 570 of elongated strap 536 mesh with the outer rack of teeth 572 of elongated strap 534 and the inner rack of teeth 570′ of elongated strap 536′ mesh with the outer rack of teeth 572′ of elongated strap 534′. The teeth are designed to index in only one direction in response to the force of the coil spring 560 urging the second ends 542 and 542′ of the first pair of elongated straps 534 and 534′ away from the second ends 550 and 550′ of the second pair of elongated straps 536 and 536′ and the anchoring base 580. Consequently, the distance between the tensioning arms 512 and 512′ will decrease in response to an increase in slack or excessive wear conditions exhibited by chain 100. As the distance between the tensioning arms 512 and 512′ decreases, a relatively constant tensioning force on chain 100 is maintained.

In order to insure that the inner racks of teeth 570 and 570′ remain securely engaged with their corresponding outer racks of teeth 572 and 572′, the coil spring seating surfaces of the second ends 550 and 550′ are angled toward the central axis of the adjusting arm 530. Concurrently, the coil spring seating surfaces of the second ends 542 and 542′ are angled outward away from the central axis of the adjusting arm. When the compressed coil spring 560 is seated between second ends 542 and 542′ and second ends 550 and 550′, its natural tendency to return to its elongated resting state generates a force on both the angled portions of second ends 542 and 542′ and the angled portions of second ends 550 and 550′ to insure that the corresponding enmeshed racks of teeth do not jump out of engagement with each other until desired in response to changing chain tension conditions.

The tensioning arms 512 and 512′ may only employ wear faces 505 or 505′ to provide tensioning in the direction of a slack or worn chain. In conjunction with the ratcheting means 555, the minimal force applied by the wear faces alone may be sufficient enough to tension certain chain drive transmission systems. This embodiment may provide the desired tension for certain power transmission systems. However, other drive transmission systems may have different tension requirements. A blade spring may be added within a recess in the body of the tensioning arm 512 to provide additional force for urging the wear face 505 into forcible sliding contact with the chain 100. Similar embodiments would include more than one blade spring, either stacked on top of one another in a single recess or placed in separate recesses along the length of the tensioning arm 512. It should be understood that tensioning arm 512′ may also incorporate at least one blade spring, if desired. The design parameters of each specific chain drive system may necessitate a tensioner 510 in which both tensioning arms 512 and 512′ contain blade springs, or one in which only one of the tensioning arms would contain blade springs. Also, neither of the tensioning arms 512 and 512′ may contain a blade spring.

Backlash is the backward or untensioned travel of a tensioning device. The combination of the amount of force provided by the wear faces 505 and 505′ and the indexing movement of the ratcheting means 555 of the invention controls the amount of backlash that occurs in the operation of a closed loop chain driven power transmission system. The gap created between the body of the tensioning arms 512 and 512′ and the under side of their respective wear faces 505 and 505′ is limited by the amount of gap clearance, previously discussed, between the ends of the wear faces 505 and 505′ and the corresponding ends of the tensioning arms 512 and 512′. The total amount of the combined gap from both tensioning arms defines the backlash in the power transmission system. Backlash determines the timing variation in the driven sprocket(s) and must be kept to a minimum. When slack in the chain cannot be absorbed because the maximum gap between the wear faces 505 and 505′ and their corresponding tensioning arms 512 and 512′ has been reached, the coil springs 560a and 560b of the ratchet means 555 provide the required force to index the meshed racks of teeth by at least one tooth and in only one direction. The indexing of the teeth increases the overlap between the pairs of elongated straps of the adjusting arm 530, and biases the second ends 509 and 509′ of the corresponding tensioning arms 512 and 512′ toward each other. The reduced distance between the second ends of the tensioning arms 512 and 512′ reestablishes forceful contact of the wear faces 505 and 505′ with their respective strands of chain 100. The unidirectional movement of the teeth prevents the adjusting arm 530 from returning to its previous elongated state which would result in an inability to tension the chain due to the loss of or a reduction in forceful contact between the wear faces 505 and 505′ and their corresponding strands of chain.

Furthermore, the clocking of the driven sprocket 104, 104′ would be restricted over that of the prior art as the anchored base 580 restricts the system's freedom to sway about the pivoting ends 509, 509′ of the arms 512, 512′.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tensioner for imparting tension to a chain of a closed loop power transmission system of an internal combustion engine comprising:
a first elongated tensioning arm having a first end and a second end positioned in operative engagement with a first strand of the chain, the first elongated tensioning arm pivotally secured to a mounting means on the engine;
a second elongated tensioning arm having a first end and a second end positioned in operative engagement with a second strand of the chain, the second elongated tensioning arm pivotally secured to the mounting means on the engine; and
an adjusting arm having a first end and a second end and a ratcheting means located substantially equidistant between the first end and the second end, wherein the first end of the adjusting arm is pivotally attached to the second end of the first elongated tensioning arm and the second end of the adjusting arm is pivotally attached to the second end of the second elongated tensioning arm, the adjusting arm further comprising two pairs of elongated straps, each elongated strap having a first end and a second end, wherein the first ends of the first pair of straps form the first end of the adjusting arm and the first ends of the second pair of straps form the second end of the adjusting arm; and
an anchoring base between two pairs of elongated straps;
wherein the second ends of the first pair of straps and the anchoring base form a first seat to retain a first coil spring and the second ends of the second pair of straps and the anchoring base for a second seat to retain a second coil spring.

2. The tensioner of claim 1 further comprising an elongated first wear face having a first end, a second end and a chain sliding face wherein the first end of the elongated wear face wraps around the first end of the first tensioning arm and the second end of the wear face wraps around the second end of the first tensioning arm so that the chain sliding face slidably contacts the chain.

3. The tensioner of claim 2 further comprising at least one blade spring disposed between the first tensioning arm and the first wear face to bias the first wear face toward the chain in response to slack conditions of the chain.

4. The tensioner of claim 1 further comprising an elongated second wear face having a first end, a second end and a chain sliding face wherein the first end of the wear face wraps around the first end of the second tensioning arm and the second end of the wear face wraps around the second end of the second tensioning arm so that the chain sliding face slidably contacts the chain.

5. The tensioner of claim 4 further comprising at least one blade spring disposed between the second tensioning arm and the second wear face to bias the second wear face toward the chain in response to slack conditions of the chain.

6. The tensioner of claim 1 further comprising a first rack of teeth on an inner surface of each of the first pair of straps proximal to the second ends of each of the first pair of straps and a second rack of teeth on an outer surface of each of the second pair of straps proximal to the second ends of each of the second pair of straps.

7. The tensioner of claim 6 wherein each first rack of teeth meshes with a corresponding adjacent second rack of teeth.
